(19) United States
(12) Patent Application Publication
(10) Pub. No.: US 2011/0168582 A1
(43) Pub. Date: Jul. 14, 2011

(54) FORMULA HELPER DEVICE

(76) Inventor: TANYA BANNISTER, Captain Cook, HI (US)

(21) Appl. No.: 13/007,597

(22) Filed: Jan. 14, 2011

Related U.S. Application Data
(60) Provisional application No. 61/294,872, filed on Jan. 14, 2010.

(51) Int. Cl. B65D 25/08; A61J 11/00

(52) U.S. Cl. 206/219; 215/11.1

(57) ABSTRACT

A formula helper device includes a dispenser bottle having a neck for receiving powdered baby formula therein. A cap has an upstanding pour spout. The cap is capable of engaging the neck of the dispenser bottle. A mechanism is for dispensing a precise amount of the powdered baby formula in the dispenser bottle through the pour spout of the cap and into a baby bottle, when the dispenser bottle is inverted over the baby bottle.

### CROSS-REFERENCE TO RELATED APPLICATION

This application claims the benefit of Provisional Patent Application No. 61/294,872, filed on Jan. 14, 2010, in the United States Patent & Trademark Office, the disclosure of which is incorporated herein by reference.

### BACKGROUND OF THE INVENTION

1. Field of the Invention

The present invention relates to a baby formula mixing system, and more particularly, a formula helper device.

The formula helper device is portable and designed to help users easily mix powdered baby formula while traveling. Parents and caretakers can mix any desired amount of the powdered baby formula with water by simply pressing one of the triggers on either side of a dispenser bottle. The present invention helps to eliminate spills and sticky messes caused while mixing the powdered baby formula on the go. It is ideal for use in cars, airplanes, restaurants, and other places outside of the home.

2. Description of the Prior Art

Parents and caretakers who travel may find it difficult to feed their babies outside of the home. Powdered baby formula may spoil if it is mixed with water too far in advance, requiring caretakers to mix the powdered baby formula as it is needed. This can become quite messy, as the powdered baby formula tends to spill easily, especially in moving vehicles. Also, powdered baby formula containers can be bulky and awkward to carry, taking up too much valuable space inside diaper bags. An efficient solution is necessary.

Numerous innovations for dosing dispensers have been provided in the prior art that will be described. Even though these innovations may be suitable for the specific individual purposes to which they address, however, they differ from the present invention.

A FIRST EXAMPLE, U.S. Pat. No. 5,000,314, Issued on Mar. 19, 1991, to Fuller et al. teaches a unit dose package, which is usable with a bottle to reconstitute the contents of the package, that has a plastic fitment which defines a mouth opening for the package. The plastic fitment is bonded to a wall of the package and has a channel which receives the neck of the bottle. A flexible foil membrane seal is removably attached to this plastic fitment and is covered by a protective overcap.

A SECOND EXAMPLE, U.S. Patent Office Publication No. 2006/0255074, Published on Nov. 16, 2006, to Amir teaches a dosing dispenser for dispensing predetermined quantities of a flowable material, particularly baby formula, includes a dosing device having a dosing compartment located to align its upper end with a receptacle for the flowable material, when the dosing device is in a rear limit position, for filling with the flowable material, and to align its lower end with a dispensing outlet when the dispensing device is in a forward limit position for dispensing the flowable material in the dosing compartment from the housing. The dispenser further includes a restraining device for restraining movement of the dosing device, when starting a movement in one direction, against movement in the opposite direction until the dosing device has completed its movement in the one direction, to thereby prevent dispensing of less than the predetermined quantity of the flowable material by only a partial filling of the dosing compartment. A vibratory action is produced when the dosing device is proved in either direction to enhance the flow of the flowable material into and out of the dosing compartment.

A THIRD EXAMPLE, U.S. Patent Office Publication No. 2007/0193894, Published on Aug. 23, 2007, to Macken et al. teaches a container for constituting a formulation in liquid form, comprises an elongate outer body split into a first section and a second section, along the longitudinal axis thereof, The container has an inner chamber divided into a first compartment and a second compartment by a seal. Seal is movable in use between a closed position, wherein the first compartment and the second compartment are sealed thereby, to an open position, wherein the first compartment and the second compartment are unsealed and any contents therein are free to mix together in the inner chamber to form the formulation. The seal is movable from the closed position to the open position by rotation of the first section relative to the second section, and the volume of the inner chamber remains unchanged following unsealing. Once the seal has been moved to the open position it is retained in that position. Reversal of the rotational movement causes an outer cover to become detached from a tear strip, permitting the outer cover to be removed and the formulation to be capable of being delivered from the container. A formulation administered from the container can ensure, for example, that a precise dose of an active ingredient is delivered to a patient, where the formulation is a pharmaceutical product.

A FOURTH EXAMPLE, U.S. Patent Office Publication No. 2009/0050494, Published on Feb. 26, 2009, to Munz teaches a mixed drink storage bottle in which a pre-determined amount of mix can be separately stored from the water such that the seal between the two can be pierced by an internally stored mixing stick to facilitate the combination of the mix with the water at the time of intended consumption.

A FIFTH EXAMPLE, U.S. Patent Office Publication No. 2009/0139882, Published on Jun. 4, 2009, to DeJonge teaches a metered trap dispenser cap with twist release valve for releasing a powder or other fluid material from a trap valve component into a container with liquid may be used for releasing medicinal, food beverage, or chemical or other component material into a liquid for time-of-use mixing and dispensing. The metered trap dispenser cap device includes an outer cap, an inner cap, a valve component and at least one screw-down deterrent mechanism connected to at least one of the inner cap and the outer cap. The outer cap includes a dispensing orifice for dispensing mixed liquid with material using a push pull nozzle mechanism, an open nozzled mechanism, a pour spout mechanism, a flip top nozzle, or the like.

A SIXTH EXAMPLE, U.S. Patent Office Publication No. 2009/0178940, Published on Jul. 16, 2009, to Said teaches a multi-chambered container assembly including a two-piece adapter having a base and a hollow member that cooperate to open and close a passage between a first chamber provided by a bottle and a second chamber formed in the hollow member. The base defines a first opening and has a substantially semi-spherical concave wall surrounding the first opening, and the hollow member includes a substantially semi-spherical convex wall that pivotally (slidably) fits within the concave wall of the base. The hollow member is snap-coupled to the base using a pair of pins and a pair of cam grooves that facilitate movement of the hollow member between a closed (first) position and an open (second) position. The base can be integrally formed onto the bottle to provide a two-piece multi-chambered container.

It is apparent now that numerous innovations for dosing dispensers have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a formula helper device that avoids the disadvantages of the prior art.

ANOTHER OBJECT of the present invention is to provide a formula helper device that is simple and inexpensive to manufacture.

STILL ANOTHER OBJECT of the present invention is to provide a formula helper device that is simple to use.

BRIEFLY STATED, STILL YET ANOTHER OBJECT of the present invention is to provide a formula helper device which comprises a dispenser bottle having a neck for receiving powdered baby formula therein. A cap has an upstanding pour spout. The cap is capable of engaging the neck of the dispenser bottle. A mechanism is for dispensing a precise amount of the powdered baby formula in the dispenser bottle through the pour spout of the cap and into a baby bottle, when the dispenser bottle is inverted over the baby bottle.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view of the present invention;

FIG. 2 is an enlarged perspective view with parts broken away, showing the cap with the pour spout exploded from the neck of the dispenser bottle;

FIG. 3 is a perspective view of the three components of the present invention separated and showing powdered baby formula being poured into the neck of the dispenser bottle;

FIG. 4 is a perspective view showing a precise amount of the powdered baby formula being dispensed from the present invention into a baby bottle; and

FIG. 5 is a perspective view showing the present invention placed into a diaper bag compartment.

### REFERENCE NUMERALS UTILIZED IN THE DRAWING

110 formula helper device
112 dispenser bottle of device 110
114 neck of dispenser bottle 112
116 powdered baby formula
118 cap of device 110
120 pour spout on cap 118
122A-122B dispensing mechanism of device 110
124 baby bottle
125 protective cover of device 110
126 first trigger of dispensing mechanism 122
128 side of dispenser bottle 112
130 second trigger of dispensing mechanism 122
132 external threads on neck 114
134 internal threads in cap 118
136 durable plastic material for device 110
138 slight concave indentations on side 128
140 hand of person 142
142 person
144 diaper bag compartment
146 bottle of water

### DETAILED DESCRIPTION OF THE PREFERRED EMBODIMENT

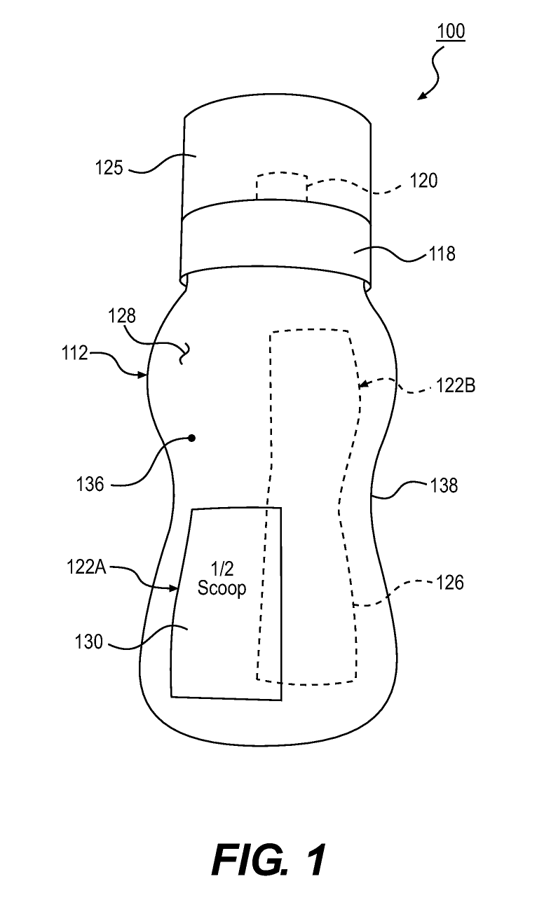

Referring now to the figures, in which like numerals indicate like parts, and particularly to FIGS. 1 through 5, and as such, will be discussed with reference thereto.

In FIG. 1: a formula helper device 110 which comprises a dispenser bottle 112 having a neck 114 for receiving powdered baby formula 116 therein. A cap 118 has an upstanding pour spout 120. The cap 118 is capable of engaging the neck 114 of the dispenser bottle 112. A mechanism 122A-B is for dispensing a precise amount of the powdered baby formula 116 in the dispenser bottle 112 through the pour spout 120 of the cap 118 and into a baby bottle 124, when the dispenser bottle 112 is inverted over the baby bottle 124.

The device 110 further comprises a protective cover 125 that snaps over the cap 118 and the pour spout 120 when the device 110 is not being used. The dispensing mechanism 122A-B comprises a first trigger 126 located on side 128 of the dispenser bottle 112B (long) to release one (01) scoop of the powdered baby formula 116 when depressed. A second trigger 130 is located oppositely on the side 128 of the dispenser bottle 112A (short) to release a half (0.5) scoop of the powdered baby formula 116 when depressed or squeezed the dispenser bottle 112.

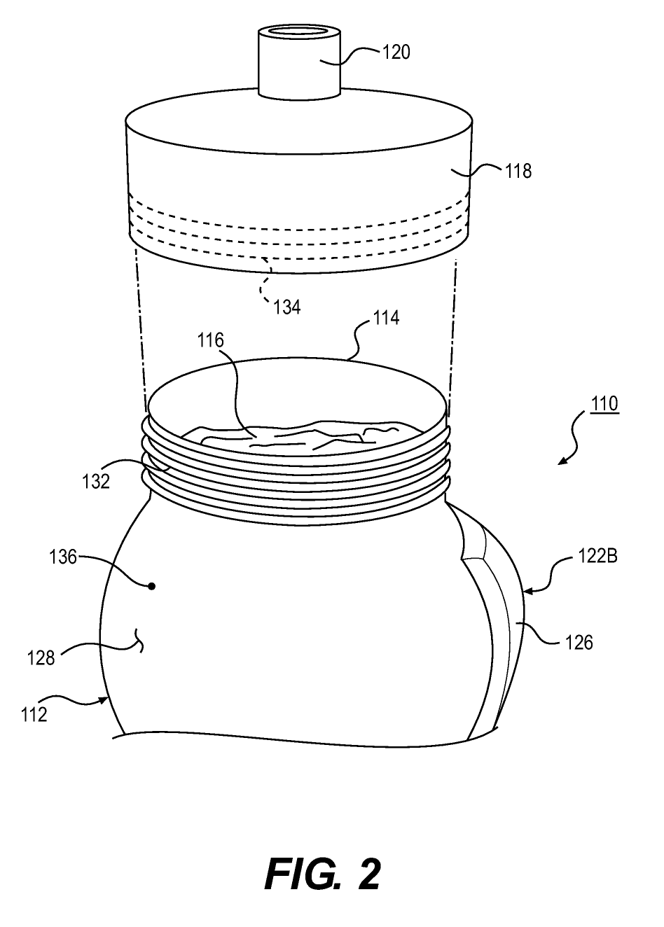

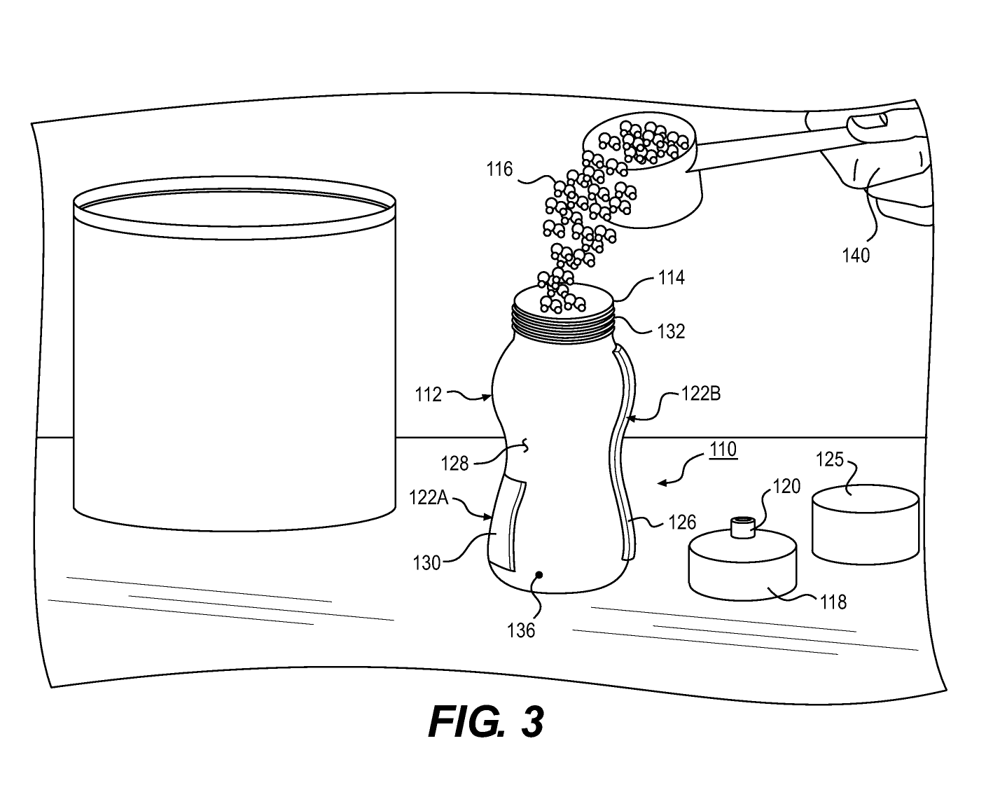

In FIGS. 2-3: the neck 114 of the dispenser bottle 112 has external threads 132. The cap 118 has internal threads 134, whereby the cap 118 can twist on and off of the neck 114 of the dispenser bottle 112. The device 110 is comprised out of durable plastic material 136.

The device 110 is of a size of approximately nine inches in length and three inches in diameter. The dispenser bottle 112 comprises slight concave indentations 138 about the side 128 for easy gripping by a hand 140 of a person 142.

In review, the formula helper device 110 affords users a quick and convenient way of mixing powdered baby formula 116 outside of the home. The device 110 includes a dispenser bottle 112 that looks like the round baby bottle 124. It is made of durable plastic material 136, and is approximately nine inches in length and three inches in diameter. Slight concave indentations 138 are included on the side 128 for easy gripping by the hand 140 of the person 142.

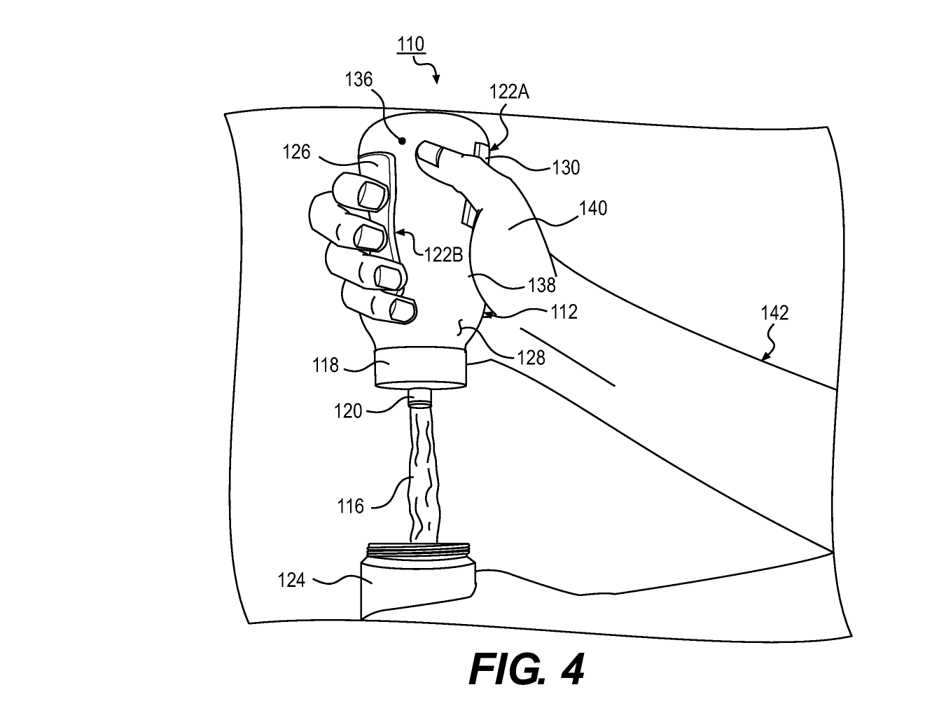

In FIG. 4: Designed to work upside down, the dispenser bottle 112 has an open neck 114 with external threads 132. A twistable cap 118 with the pour spout 120 has internal threads 134 that can engage with the external threads 132 on the neck 114. When in use, the pour spout 120 will deliver optimal accuracy, helping to reduce the incidence of messy spills (e.g. mixing milk on the vehicle during traveling, . . . ). The twistable cap 118 is removed from the neck 114 to allow the person 142 to fill the dispenser bottle 112 with the powdered baby formula 116. The protective cover 125 is used to cover the twistable cap 118 when the device 110 is not being used. The two triggers 126, 130 of the dispensing mechanism 122 are located oppositely on the side 128 of the dispensing bottle 112. The first trigger 126 (long 122B) will release 8.5 grams of the powdered baby formula 116, which is equal to one scoop of the powdered baby formula 116, while the second trigger 130 (short 122A) will release 4.25 grams of the powdered baby formula 116, which is equal to a half scoop of the powdered baby formula 116. The first trigger 126 is a rectangular with 8 inches in length (1 inch in width and 5 mm in thickness) and the second trigger 130 is a rectangular with 4 inches in length (1 inch in width and 5 mm in thickness). The dispensing bottle 112 has a thickness of 1-4 mm and has made of durable plastic. The triggers have the same material as of the dispensing bottle but thicker one millimeter (e.g. 5 mm compares to 1-4 mm).

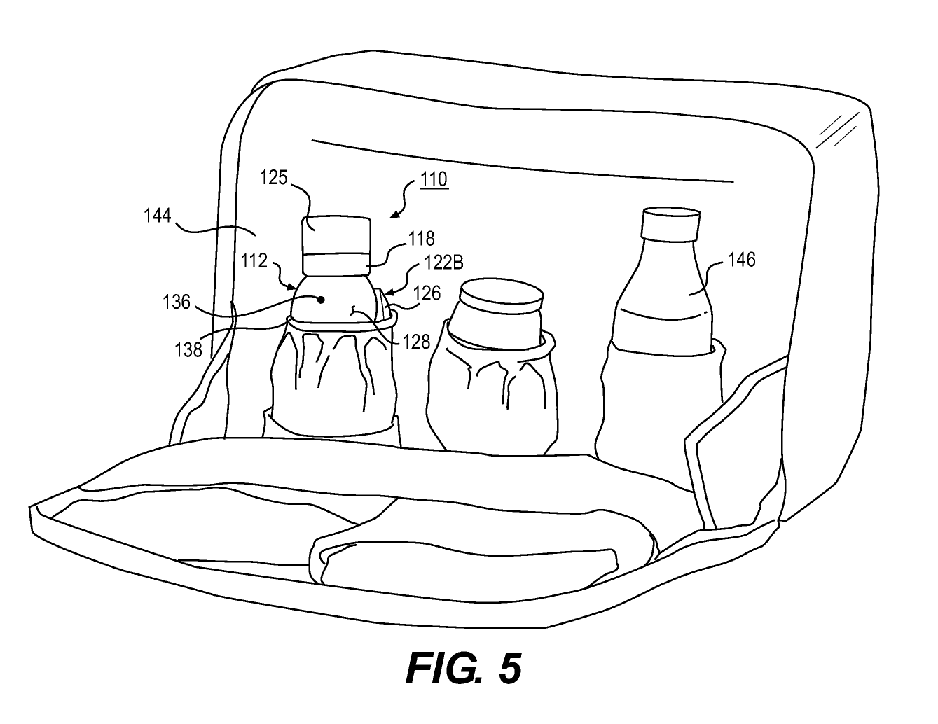

In FIG. 5: the triggers 126, 130 ensure precise measurements for mixing. Once the proper amount of powdered baby formula 116 is placed within the baby bottle 124 a bottle of water 146 can be poured into the baby bottle 124 and mixed together. The device 110 may be available in a variety of colors to suit user preferences and may be placed into a diaper compartment 144. The exact specifications may vary.

It will be understood that each of the elements described above, or two or more together, may also find a useful application in other types of constructions differing from the types described above.

While the invention has been illustrated and described as embodiments of a formula helper device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A formula helper device for providing precise amounts of formula powder into a baby bottle, which comprises:
a) a dispenser bottle having a neck with external threads for receiving powdered baby formula therein;
b) a cap having an upstanding pour spout and internal threads, the cap capable of engaging the neck of the dispenser bottle; and
c) trigger means for dispensing a precise amount of the powdered baby formula in the dispenser bottle through the pour spout of the cap and into the baby bottle, when the dispenser bottle is inverted over the baby bottle.

2. The device as recited in claim 1, further comprises a protective cover that snaps over the cap and the pour spout when the device is not being used.

3. The device as recited in claim 1, wherein the trigger means for dispensing comprises:
a) a first trigger located on side of the dispenser bottle to release one scoop of 8.5 grams of the powdered baby formula when depressed on the first trigger in squeezing manner; and
b) a second trigger located oppositely on the side of the dispenser bottle to release a half scoop of 4.25 grams the powdered baby formula when depressed on the second trigger in squeezing manner.

4. The device as recited in claim 1, further comprising:
a) the neck of the dispenser bottle having external threads; and
b) the cap having internal threads, whereby the cap can twist on and off of the neck of the dispenser bottle.

5. The device as recited in claim 1, wherein the device is comprised out of durable plastic material and has a thickness of 1-4 mm.

6. The device as recited in claim 1, being of a size of approximately nine inches in length and three inches in diameter.

7. The device as recited in claim 1, wherein the dispenser bottle comprises slight concave indentations about the side for easy gripping by a hand of a person.

8. The device as recited in claim 3, wherein the first trigger is a rectangular with 8 inches in length (1 inch in width and 5 mm in thickness) and the second trigger 130 is a rectangular with 4 inches in length (1 inch in width and 5 mm in thickness).
